(19) United States
(12) Patent Application Publication
(10) Pub. No.: US 2010/0250228 A1
(43) Pub. Date: Sep. 30, 2010

(54) MODELING A COMPOSITE APPLICATION

(75) Inventors: David Cohn, Dobbs Ferry, NY (US); Pankaj Dhoolia, New Delhi (IN); Fenno F. Heath, III, Woodbridge, CT (US); Hemesh Kumar, New Delhi (IN); Santhosh Kumaran, Peekskill, NY (US); Rong Liu, Sterling, VA (US); Florian Pinel, New York, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/413,749

(22) Filed: Mar. 30, 2009

(51) Int. Cl. G06F 9/45

(52) U.S. Cl. 703/22; 718/100

(57) ABSTRACT

Techniques for modeling a composite application are provided. The techniques include identifying one or more entities that are processed in a user enterprise, identifying one or more actions to be performed during a lifecycle of the one or more entities, and modeling a composite application based on the one or more actions to be performed during a lifecycle of the one or more entities.

### FIELD OF THE INVENTION

Embodiments of the invention generally relate to information technology, and, more particularly, to composite applications.

### BACKGROUND OF THE INVENTION

Traditionally, the notion of an application provider had been very limited. In the new web 2.0 and participation age, however, that is no longer the case. The end-user is increasingly assuming the role of provider. This phenomenon of end-user as a provider, though, is customarily limited to the end-user's personal content. The end-user is not empowered enough to extend his or her participation to start creating and offering his or her enterprise his or herself. Existing approaches for creating composite enterprise applications are oriented towards the information technology (IT) industry.

Even in the IT industry, the contemporary set of tools is often geared towards technical users. An enterprise analyst or a subject matter expert, for example, may not be able to use existing approaches to specify a composite application. Also, using existing approaches, a user or individual may find it even more complex to communicate with the customer.

### SUMMARY OF THE INVENTION

Principles and embodiments of the invention provide techniques for modeling a composite application. An exemplary method (which may be computer-implemented) for modeling a composite application, according to one aspect of the invention, can include steps of identifying one or more entities that are processed in a user enterprise, identifying one or more actions to be performed during a lifecycle of the one or more entities, and modeling a composite application based on the one or more actions to be performed during a lifecycle of the one or more entities.

One or more embodiments of the invention or elements thereof can be implemented in the form of a computer product including a tangible computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating modeling of a composite application, according to an embodiment of the present invention;

FIG. 2 is a diagram illustrating a schema for a composite application specification, according to an embodiment of the present invention;

FIG. 3 is a diagram illustrating a manufacturer-centered innovation and a user-centered innovation, according to an embodiment of the present invention;

FIG. 4 is a diagram illustrating an exemplary templates toolbar, according to an embodiment of the present invention;

FIG. 5 is a diagram illustrating an exemplary enterprise entity template, according to an embodiment of the present invention;

FIG. 6 is a diagram illustrating an exemplary service template, according to an embodiment of the present invention;

FIG. 7 is a diagram illustrating a screenshot of an exemplary external service template, according to an embodiment of the present invention;

FIG. 8 is a diagram illustrating a screenshot of an exemplary access control template, according to an embodiment of the present invention;

FIG. 9 is a diagram illustrating a screenshot of an exemplary new composite application, according to an embodiment of the present invention;

FIG. 10 is a diagram illustrating a screenshot of an exemplary new enterprise component, according to an embodiment of the present invention;

FIG. 11 is a diagram illustrating an image of an exemplary default state machine, according to an embodiment of the present invention;

FIG. 12 is a diagram illustrating an image of a state machine after cut-copy-paste and modify, according to an embodiment of the present invention;

FIG. 13 is a diagram illustrating a screenshot of an exemplary edit information model, according to an embodiment of the present invention;

FIG. 14 is a diagram illustrating a screenshot of an exemplary modify information model, according to an embodiment of the present invention;

FIG. 15 is a diagram illustrating a screenshot of an exemplary view all exposed services option, according to an embodiment of the present invention;

FIG. 16 is a diagram illustrating a screenshot of an exemplary component's exposed services view, according to an embodiment of the present invention;

FIG. 17 is a diagram illustrating a screenshot of an exemplary new component service option, according to an embodiment of the present invention;

FIG. 18 is a diagram illustrating a screenshot of an exemplary expose a service on a component part option, according to an embodiment of the present invention;

FIG. 19 is a diagram illustrating an exemplary default (mock) service plan, according to an embodiment of the present invention;

FIG. 20 is a diagram illustrating a screenshot of an exemplary invoking a service option, according to an embodiment of the present invention;

FIG. 21 is a diagram illustrating an image of exemplary service invocation choices, according to an embodiment of the present invention;

FIG. 22 is a diagram illustrating a screenshot defining invocation mapping, according to an embodiment of the present invention;

FIG. 23 is a diagram illustrating a screenshot of an exemplary expression builder, according to an embodiment of the present invention;

FIG. 24 is a diagram illustrating a screenshot of an exemplary iteration of a task, according to an embodiment of the present invention;

FIG. 25 is a diagram illustrating a screenshot of selecting an enumerator on which to iterate, according to an embodiment of the present invention;

FIG. 26 is a diagram illustrating an exemplary iterated task, according to an embodiment of the present invention;

FIG. 27 is a diagram illustrating a screenshot of removing a task iterator, according to an embodiment of the present invention;

FIG. 28 is a diagram illustrating a screenshot of registering an external service, according to an embodiment of the present invention;

FIG. 29 is a diagram illustrating a screenshot of an exemplary external service wizard dialog, according to an embodiment of the present invention;

FIG. 30 is a diagram illustrating an exemplary external service slide, according to an embodiment of the present invention;

FIG. 31 is a block diagram of a non-limiting exemplary embodiment, according to an aspect of the invention;

FIG. 32 is a flow diagram illustrating techniques for modeling a composite application, according to an embodiment of the present invention;

FIG. 33 is a flow diagram illustrating techniques for modeling a composite application, according to an embodiment of the present invention; and

FIG. 34 is a system diagram of an exemplary computer system on which at least one embodiment of the present invention can be implemented.

### DETAILED DESCRIPTION OF EMBODIMENTS

Principles of the invention include techniques for simplified modeling of a composite application. One or more embodiments of the invention include enterprise-entities oriented, template-driven techniques for creating composite applications. By way of example, an embodiment of the invention can include a simplified modeling environment that plugs into power-point and, using presentation slides and spreadsheets, allows a user to model a composite application. The techniques described herein can include the use of a set of templates for core-notions of the composite-application that allow the user to specify the model in a template- and/or example-oriented manner, which the user can further alter by cutting and/or copy as well as pasting and/or re-naming.

One or more embodiments of the invention can also include architecture of verification of a model created using Petri-net based reach-ability analysis or simulation and guided correction of model errors. Additionally, the techniques described herein can include using a radically simplified meta-model that provides a complete formal definition of the structure of the composite application.

Also, as detailed herein, one or more embodiments of the invention include a transformation apparatus, wherein a model thus created using the techniques noted herein can be transformed to a composite application meta-model. Such a transformed model can be, for example, deployed on a model execution environment based on its meta-model, or can be transformed to other meta-models based on different specification (for example, Unified Modeling Language (UML), Service Component Architecture (SCA), Petri-nets, etc.).

In contrast to the disadvantages of existing approaches, one or more embodiments of the invention include direct modeling of enterprise-entities as a combination of an information structure, a lifecycle that an information structure gets processed through, and services exposed and consumed in the context of that lifecycle. Additionally, the techniques detailed herein include platform-independent modeling of the service-invocational bindings (for example, full mapping from a caller's information context to a callee's needs). The platform-independent mapping of the information context of a task in execution plan of a service is transformed to the information context required by the callee.

One or more embodiments of the invention also include automatic determination of the available information-structure in the context of any behavioral node (for example, a task in the execution plan of a service in the context of the lifecycle of an enterprise entity, or the state and/or transition of the lifecycle of an enterprise entity) and making it available for the mapping (as noted above). As such, the techniques described herein can intelligently determine what the information context available at a particular behavioral (lifecycle-state and/or flow-task) node is, thereby facilitating a modeler to, without much ado, specify interactions or constraints.

Additionally, one or more embodiments of the invention include simple registration and use of an external service. By way of example, by pointing to the uniform resource identifier (URI) of an external representational state transfer (REST) and/or web services description language (WSDL) driven service, that URI is made available to be invoked and bound (in the context of the composite application). The declared URI pulls an available external resource and makes it available for invocation from the relevant model elements.

The techniques detailed herein can also include upfront verification and simulation of the composite application to detect possible bottleneck and deadlock situations in the model (for example, automated Petri-net based verification of the model). Verification and/or simulation via Petri-nets can be integrated into the modeling. As such, the user is progressively made aware of detected dead-lock situations or bottlenecks as he or she is modeling.

Further, specific to a Power-point based embodiment of the invention, one is able to incrementally detect and handle changes such as slide-deletion, copy and/or paste of shapes, etc. that are otherwise not made available by component object model (COM) interfaces. Also, one or more embodiments of the invention include making composite application modeling available in a pervasive, presentation software (such as, for example, Microsoft PowerPoint) with very little ramp-up time required for users.

By way of example, consider a typical computer user that is familiar with presentations and spreadsheets. One or more embodiments of the invention enable users to design applications using commonly available presentation and spreadsheet software as development tools, wherein the modeling environment detailed herein can be an add-in to such software. As depicted in the accompanying figures, one can use presentational diagrams based on shapes and connectors to specify lifecycles, and flows, as well as use spreadsheets embedded with relevant diagrams to further specify information models.

As described herein, one or more embodiments of the invention include templates for the core-notions of the composite-application. While creating the composite-application using the techniques detailed herein, a user can specify, for example, one or more of the following core pieces. Enterprise entities are the core information-structures that the enterprise of the user processes. Services are the specific actions that are intended to be performed on the enterprise entity during its lifecycle. External services are the externally available services with well-defined REST/WSDL interfaces that can be leveraged in the execution-plan of a user-specified service. Also, access control is the set of policies that, based on the specified role- and information-based rules, allow or disallow access to the services and/or information offered by enterprise-entity resources.

For each of the above exemplary core pieces, one or more embodiments of the invention include offering pre-define templates with samples and documents that guide and allow the user to modify and adapt the corresponding slides created using the templates for their specific scenario.

Additionally, as described herein, one or more embodiments of the invention include model verification and correction. While creating the composite-application using the techniques described herein, human error may occur on the part of the user. As such, one or more embodiments of the invention provide for the user to verify the modeled composite application at anytime. Internally, the user created application can be transformed to Petri-nets and a Petri-net based reach-ability analysis and simulation can be performed to verify the model. Any discovered errors can be reported to users and assistance can be provided in pointing and taking the user to the right error for correction.

One or more embodiments of the invention can also include a composite application meta-model. A meta-model allows specifying a composite application as a set of communicating enterprise-entities that, for example, may be using declared external services. An enterprise entity can have an information-model and a lifecycle, wherein an information-model is a logical grouping of information and a lifecycle specifies the finite number of states and the transition possibilities therein. Additionally, actions (with guards) can be modeled at the lifecycles transitions with a specified plan of task execution.

The techniques described herein can also include a transformation apparatus that converts a power-point and/or spreadsheet based model to a composite application meta-model. The composite application meta-model can be deployed, played, and/or interacted with immediately on an execution environment for the composite application meta-model. Also, the composite application meta-model can be transformed to any other specific platform of implementation and deployment and/or any other modeling specification.

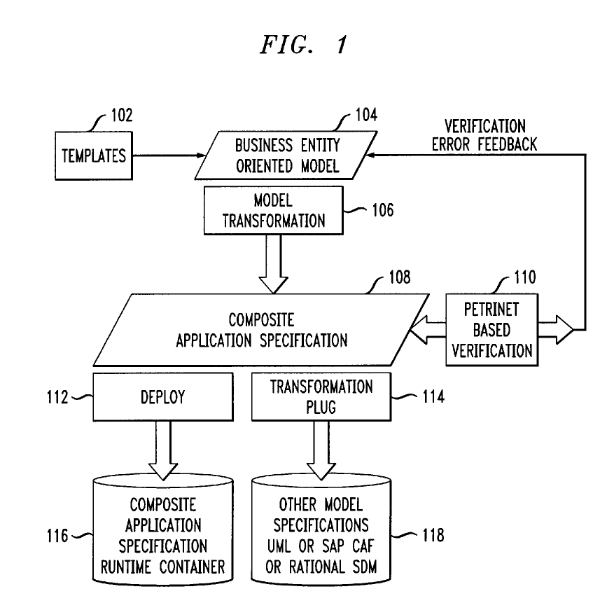

FIG. 1 is a diagram illustrating modeling of a composite application, according to an embodiment of the present invention. By way of illustration, FIG. 1 depicts templates 102, an enterprise entity-oriented model 104, as well as model transformation in step 106. FIG. 1 also depicts a composite application specification 108 and Petrinet-based verification in step 110 (that may include producing verification error feedback). Additionally, step 112 includes deploying the composite application specification into a run-time container 116, and step 114 includes using a transformation plug to combine with other model specifications, unified modeling language (UML) or SAP composite application framework (CAF) or a rational service design model (SDM) 118.

The techniques described herein and depicted, for example, in FIG. 1 can include determining what it is that an enterprise processes and modeling those items as enterprise-entities (for example, using a provided template). One can declare the lifecycle of the enterprise entity using cut, copy, paste and/or rename on the corresponding template. Additionally, one can declare the information content of the enterprise entity.

One or more embodiments of the invention also include creating services associated to the lifecycle context of the enterprise-entities (for example, using a provided template) towards declaring communication between the enterprise-entities and/or declaring any complex or granular processing steps. One can also detail associated services. For example, one can declare input and output messages, the service plan (including tasks, woven together using general flow semantics), as well as bindings with other services and/or computational scripts, etc. to the tasks in the service-plan to accomplish desired goals.

As noted, the techniques described herein can also include registering any external services (for example, REST/WSDL based services) into a model (for example, using a provided template) and verifying and/or generating an application specification. One or more embodiments of the invention also include transforming an application specification to other model specifications, as well as deploying the application specification to a compliant runtime container.

An apparatus implementing the techniques described herein can, for example, plug-in to presentation software using a presentational diagram semantic to specify state and/or flow based behaviors and using embedded spreadsheet semantic to specify an information model. One or more embodiments of the invention also include a template-oriented approach that, for example, can recommend cut, copy, paste and/or rename approaches, as well as use embedded help and/or guidance directly on the templates.

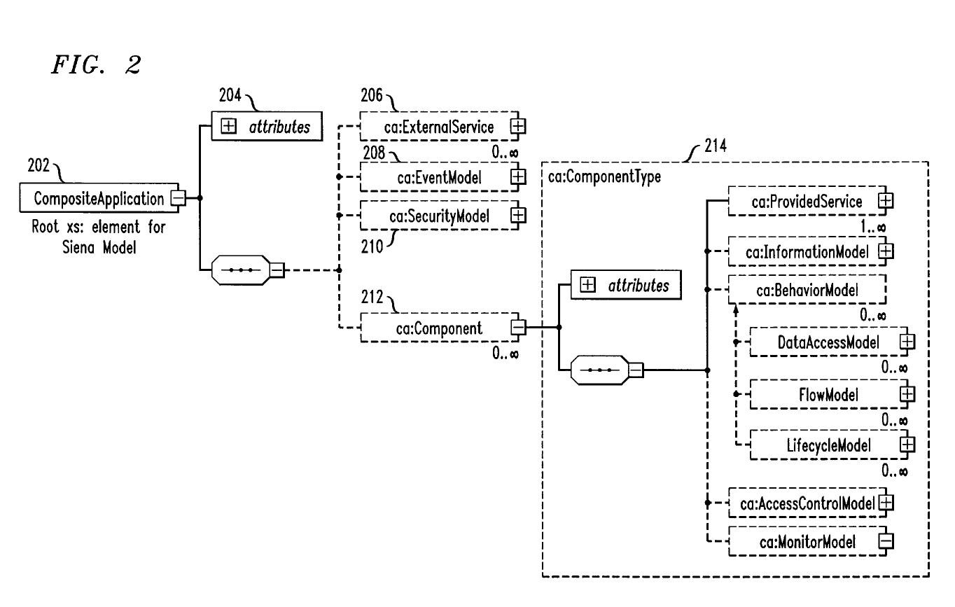

FIG. 2 is a diagram illustrating a schema for a composite application specification, according to an embodiment of the present invention. By way of illustration, FIG. 2 depicts a composite application node 202, a set of attributes 204 that are associated to the composite application (for example, name, uniform resource identifier (URI), version, etc.), and a set of external services 206 that the composite application uses. External services refer to services already provided by some external provider. The sub-structure captures details of the external service include, for example, name, URI, input details, output details, etc. FIG. 2 also depicts a set of events 208 that the composite application as a whole exposes to the external world for interaction.

Additionally, FIG. 2 depicts a node 210 that captures the roles and policies applicable to the composite application. By way of example, this node 210 can capture security role definitions that are applicable across multiple components of the composite application. The node 210 can also capture named security policies that state a combination of the role, rights (read, write and/or execute), resources (components' information model and provided services) and rules (for example, Boolean expressions based on the information model of the components in the composite application).

Further, as illustrated in FIG. 2, component 212 defines the components specified as a part of the composite application (of 202), and component 214 defines the details of component 212. A component has an information model, which defines the information structure details for the component (for, it can link a schema containing the information structure specification, and stating what element in that schema is the root element towards the information structure). Also, a component specifies behavior models. For example, a lifecycle model specifies the details of the state lifecycle and the related transitions that the information structure for the component goes through. The flow-model specifies the activities that are either available on-demand to be performed when the component is in a particular state, or activities that happen during the transition of the component from one state to the other. Additionally, the data-access model defines specialized ways of querying about the information model of the component.

The access control model, on the pattern of the security-model (applicable across the component), defines component-contained security roles and policies. Also, the monitor model defines component-contained monitors and related response activities associated to those monitors in case of failures. For example, it enables constructs such as monitoring the turnaround-around-time the component instances take to go from the state of creation to the state of archival, and if it is more than threshold t, then it performs the activity defined as flow f in the flow model. Furthermore, provided services are the set of services that a component exposes for any consumer to consume. This can include, for example, triggers for the lifecycle transitions and the exposed data access services.

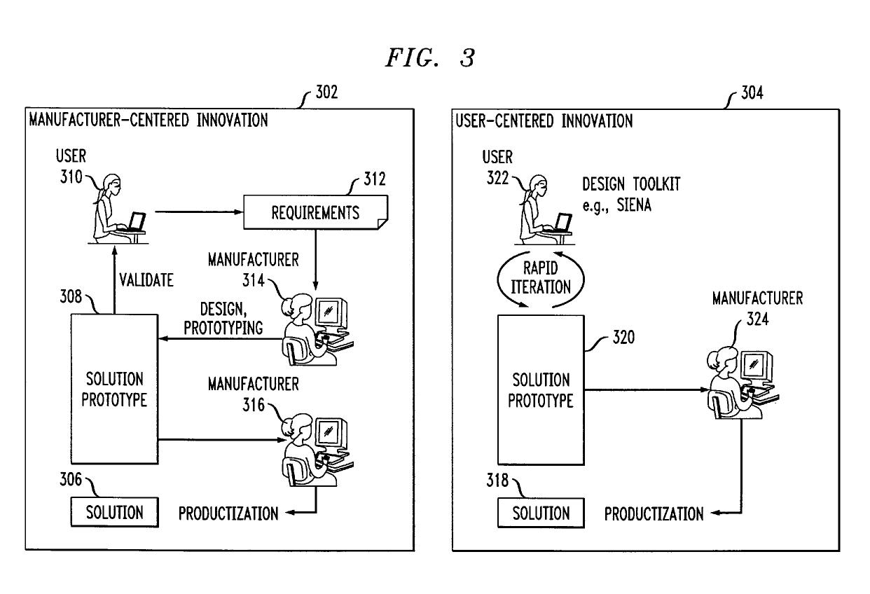

FIG. 3 is a diagram illustrating a manufacturer-centered innovation 302 and a user-centered innovation 304, according to an embodiment of the present invention. As depicted in FIG. 3, the manufacturer-centered innovation 302 includes a solution 306, a solution prototype 308 which is validated by a user 310, requirements 312 and a manufacturer 314 that designs and prototypes. Also, manufacturer 316 productizes the solution prototype (once agreed upon) to the actual solution.

Additionally, the user-centered innovation 304 includes a solution 318, a solution prototype 320 that undergoes rapid iteration from a user 322, and a manufacturer 324. In the manufacturer centric view, the user can come up with the requirement and then the entire act of prototyping, etc. towards it is done by the manufacturer, and working back and forth in this reconciliatory manner, once the user and the manufacturer reach an agreement in terms of the expectations and the prototype, the manufacturer proceeds to create a productized solution. With the simplification design toolkit, however, the user is empowered to carry out the prototyping, and the manufacturer comes in to simply productize the clearly visible design only when the user has the design thrashed out.

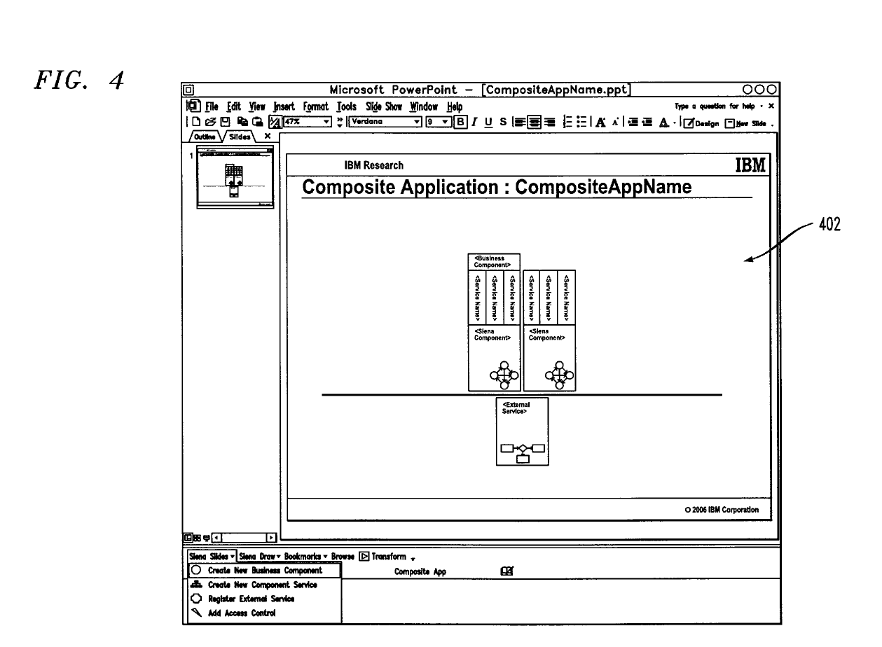

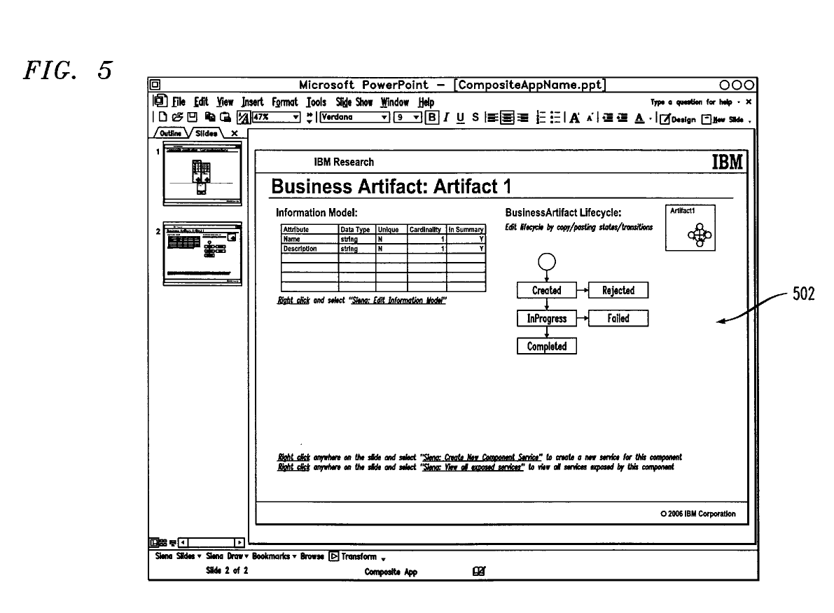

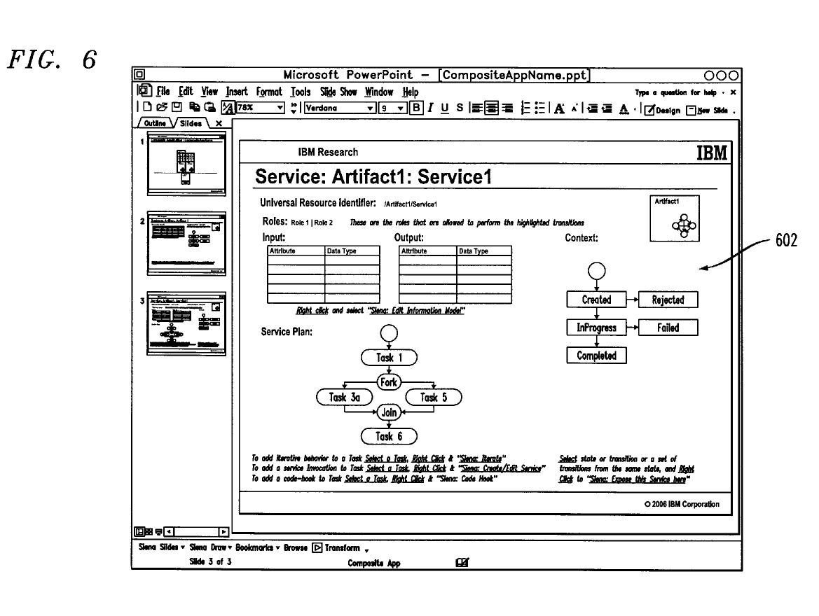

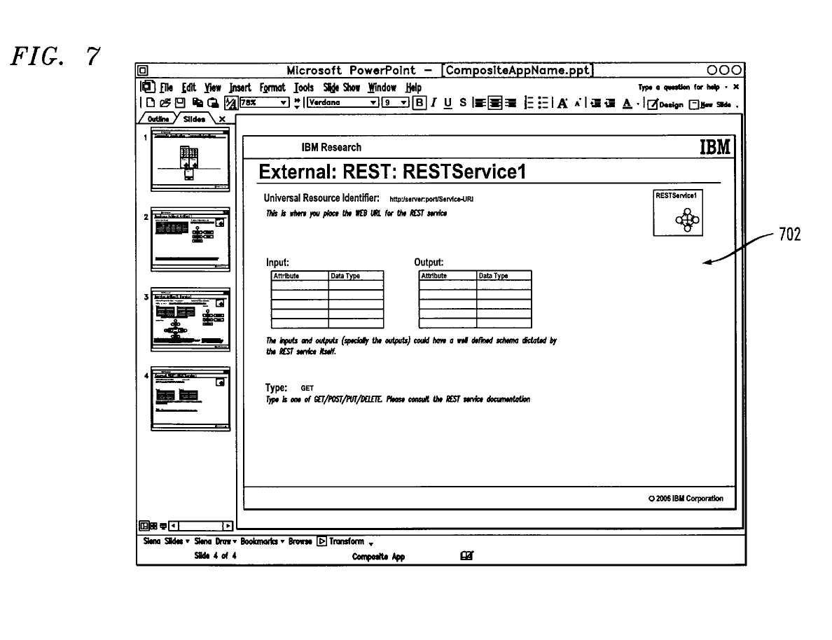

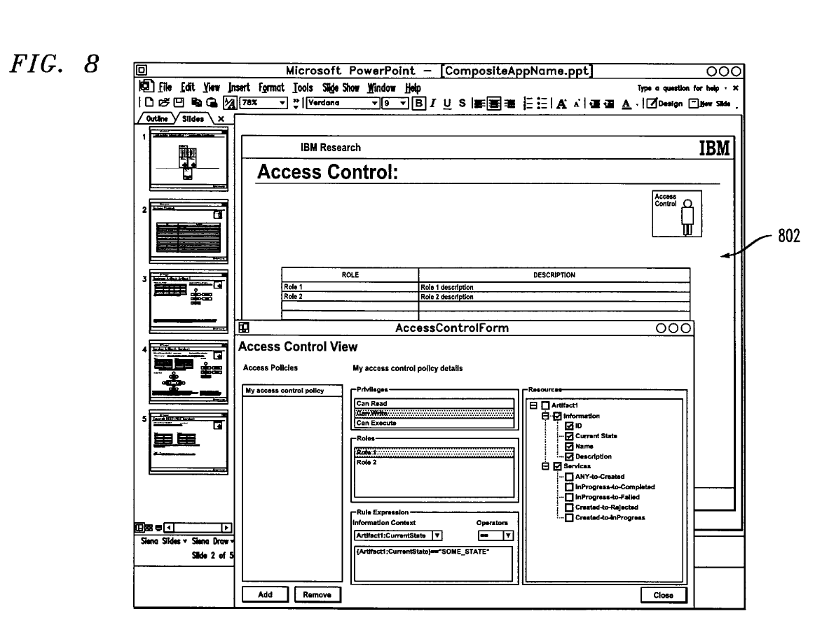

FIG. 4 through FIG. 8, by way of example, illustrates exemplary templates that can be used in one or more embodiments of the invention. FIG. 4 is a diagram illustrating a screenshot of an exemplary templates toolbar 402, according to an embodiment of the present invention. FIG. 5 is a diagram illustrating a screenshot of an exemplary enterprise entity template 502, according to an embodiment of the present invention. FIG. 6 is a diagram illustrating a screenshot of an exemplary service template 602, according to an embodiment of the present invention. FIG. 7 is a diagram illustrating a screenshot of an exemplary external service template 702, according to an embodiment of the present invention. FIG. 8 is a diagram illustrating a screenshot of an exemplary access control template 802, according to an embodiment of the present invention.

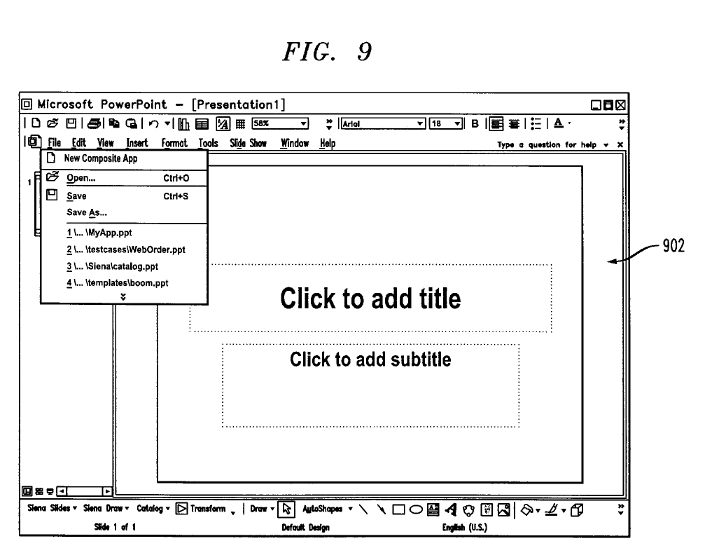

FIG. 9 through FIG. 30 illustrates one or more exemplary embodiments of the invention. FIG. 9 is a diagram illustrating a screenshot of an exemplary new composite application 902, according to an embodiment of the present invention. By way of example, after installing a Siena Toolkit, one can click on the “File” menu of Microsoft PowerPoint and choose “New Composite App.” FIG. 10 is a diagram illustrating a screenshot of an exemplary new enterprise component 1002, according to an embodiment of the present invention. After creating a new composite application, one can, by way of example, click on the Siena Slides menu of the Siena toolbar, and choose “Create New Business Component.”

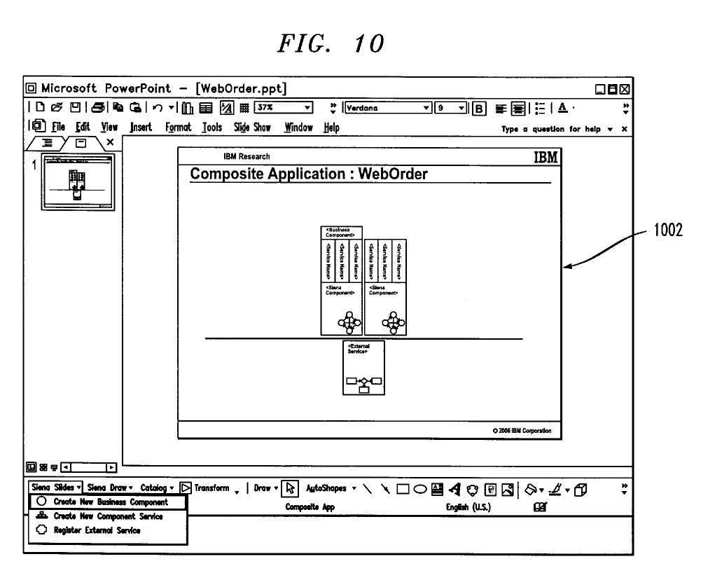

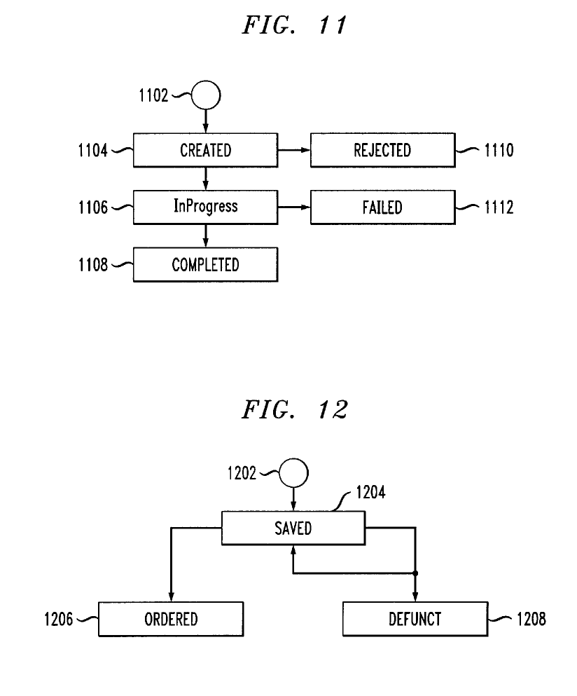

FIG. 11 is a diagram illustrating an image of an exemplary default state machine, according to an embodiment of the present invention. By way of illustration, FIG. 11 depicts the start-node 1102 for the state lifecycle, created status 1104, in progress status 1106, completed status 1108, rejected status 1110 and failed status 112. A Siena Business Component template, by way of example, can put a default state machine by default (this state machine dictates the component's exposed ports model). One can, for instance, use that as a starting point, and use copy-paste-modify to modify its state protocol behavior. For example, the default state machine that is part of the template and looks like the image in FIG. 11 can be modified via cut-copy-paste-modify to resemble the image in FIG. 12.

FIG. 12 is a diagram illustrating an image of a state machine after cut-copy-paste and modify, according to an embodiment of the present invention. By way of illustration, FIG. 12 depicts the start-node 1202 for the flow, saved status 1204, ordered status 1206 and defunct status 1208. By way of example, one or more embodiments of the invention at this point can require the round initial state and the connectors to be actually connected on both the sides to the states. An alternative, for example, to the cut-copy-paste modify can be to use the primitives from the “Draw” menu of a Siena toolbar.

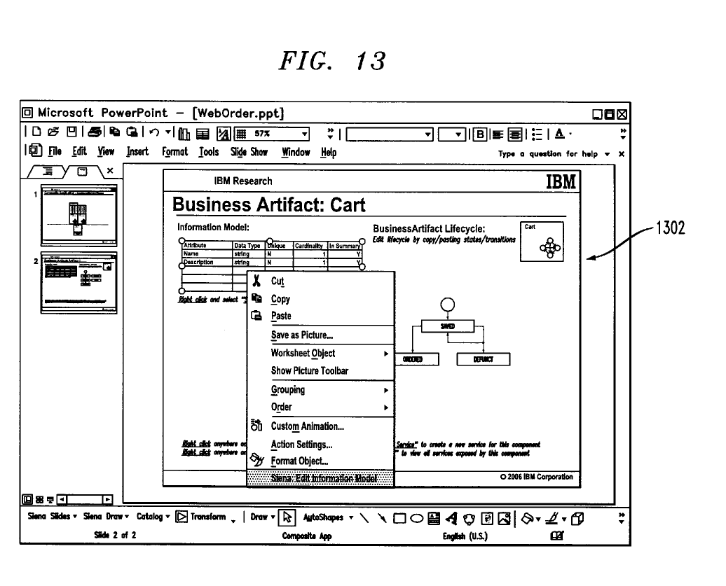

FIG. 13 is a diagram illustrating a screenshot of an exemplary edit information model 1302, according to an embodiment of the present invention. By way of example, on a “Component” slide, one can right-click on the embedded spreadsheet for the information model and select “Edit Information Model.”

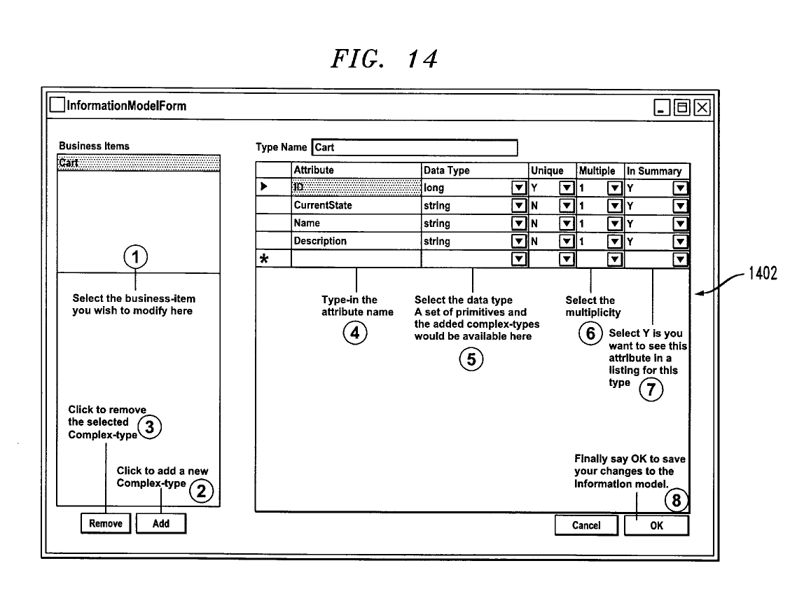

FIG. 14 is a diagram illustrating a screenshot of an exemplary modify information model 1402, according to an embodiment of the present invention. One can, by way of example, see a complex-type (or enterprise-item) corresponding to the component name already created with a set of default attributes. One can add new complex-types, define their attributes and use them as data-types of attributes in other complex-types. As soon as one adds a complex-type, it will become available in the data-type drop-down (for other enterprise items' attributes). As such, one can select the row of the attribute and delete it. Similarly, one can select a complex-type and remove it.

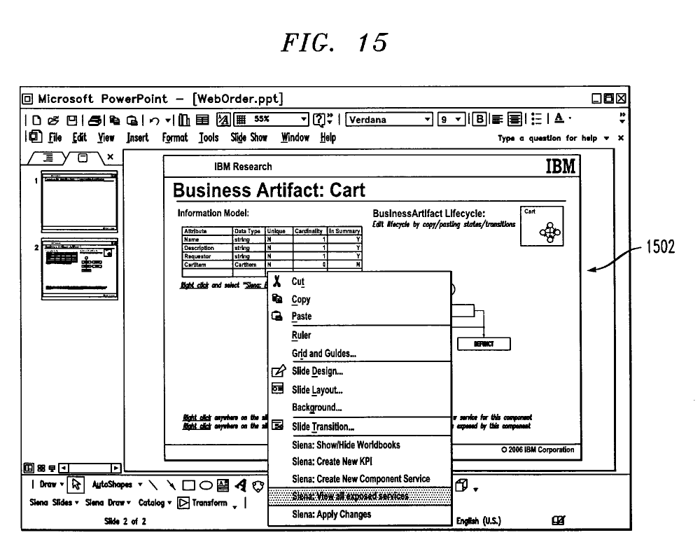

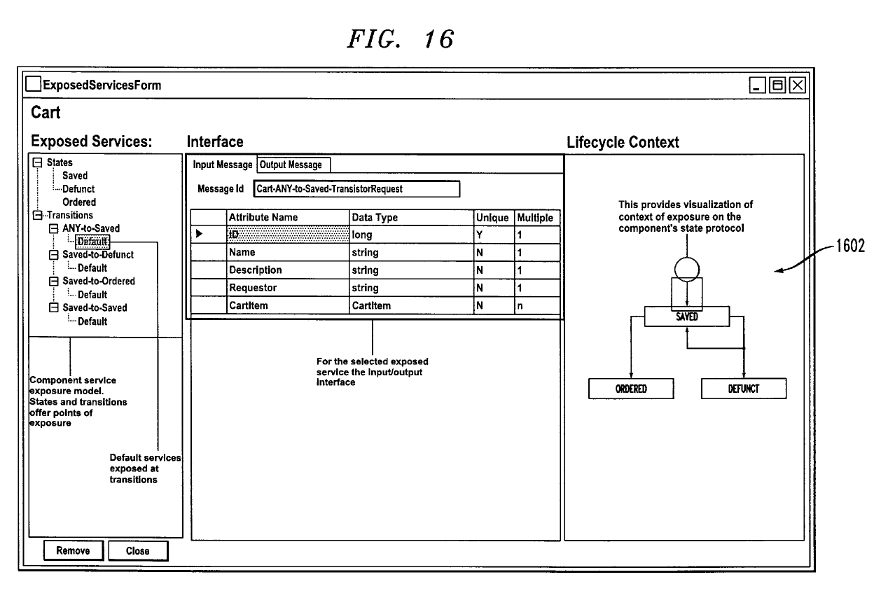

FIG. 15 is a diagram illustrating a screenshot of an exemplary view all exposed services option 1502, according to an embodiment of the present invention. At any point of time, on the component slide, one can right-click and choose “View all Exposed Services.” FIG. 16 is a diagram illustrating a screenshot of an exemplary component's exposed services view 1602, according to an embodiment of the present invention. As shown in FIG. 16, based on the component's behavioral model, the possible service-ports along with the services actually exposed on those ports can be listed on the left. One can further select any of the services to see the corresponding service interface (input/output) in the middle. As also depicted by FIG. 16, a diagrammatic visualization of the port of context for service exposure can be displayed at the right.

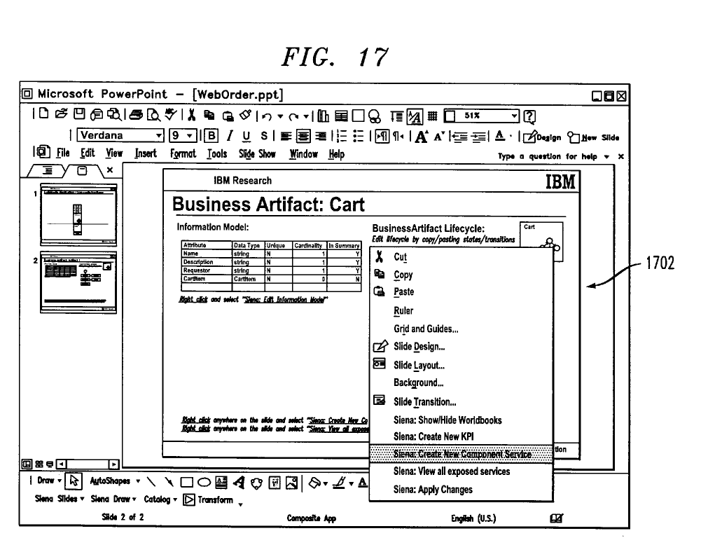

FIG. 17 is a diagram illustrating a screenshot of an exemplary new component service option 1702, according to an embodiment of the present invention. As shown in FIG. 17, one can right-click on the component slide and choose “Create New Component Service.” FIG. 18 is a diagram illustrating a screenshot of an exemplary expose a service on a component part option 1802, according to an embodiment of the present invention. On the Service slide, one can right-click on a state or a transition or a group of transitions with the same source state on the component's behavioral context (shown in the context area), and choose “Expose this Service here.” For Siena components, for example, states and/or transitions define the component's port model.

On the service slide, one can right-click on the input/output embedded sheet for the service message model, and choose “Edit Information Model.” Subsequently, one can follow the same instructions as while editing a component's information model (as described in connection with FIG. 13).

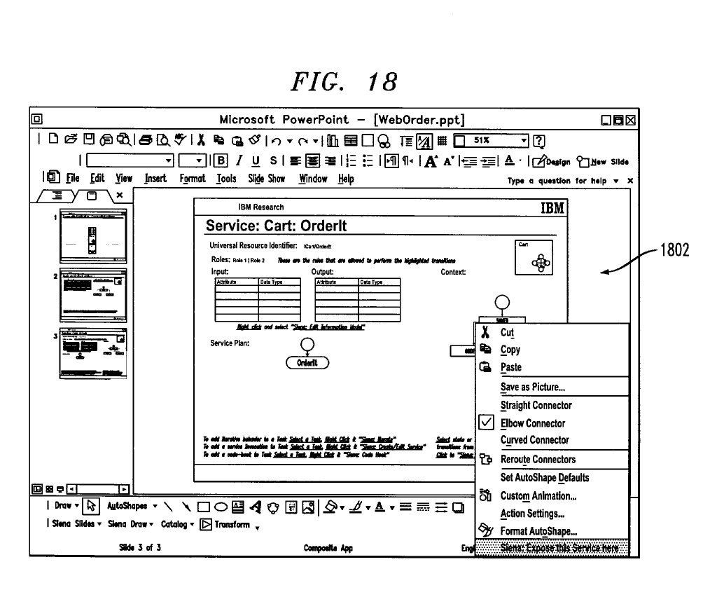

FIG. 19 is a diagram illustrating an exemplary default (mock) service plan, according to an embodiment of the present invention. By way of illustration, FIG. 19 depicts a general template used for starting a flow (an instance of which is already captured in FIG. 12), and includes the start-node 1902 for the flow, task1 1904, which forks into task3a 1906 and task5 1908, which then join to form task6 1910. By way of example, on a component service slide, one may have already observed that there are three distinct aspects of the service: the service input/output interface, the service port of exposure, and the service implementation plan. To define the service plan, one can, for example, use a cut-copy-paste-modify approach similar to modeling of the component's state protocol. The service template, by default, can have a mock service plan definition that looks like the image in FIG. 19. One can also, for instance, use cut-copy-paste to modify it as desired. Additionally, one can name the tasks (for example, to mean what each task is intended to do) and subsequently define these tasks to invoke some other service, or to iterate, or bind computational hooks to them.

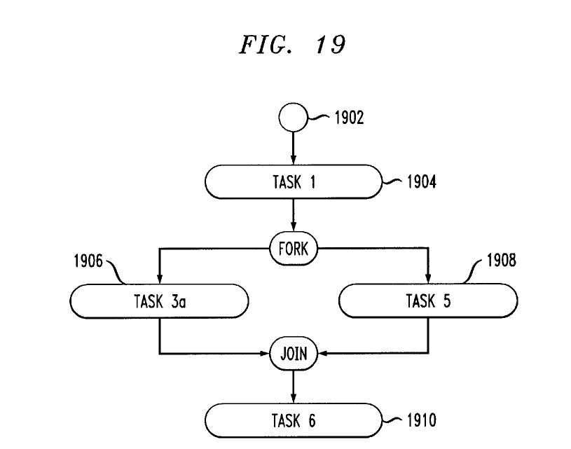

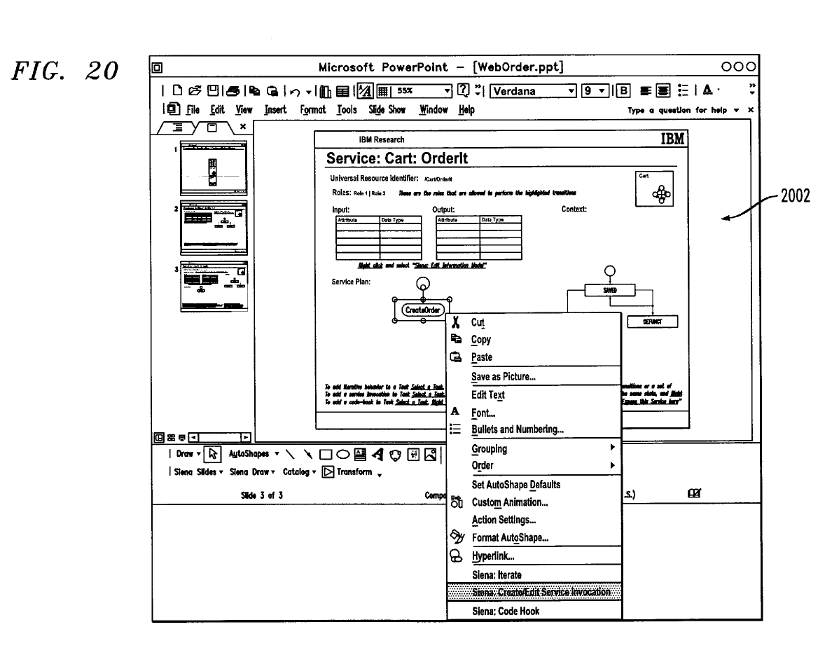

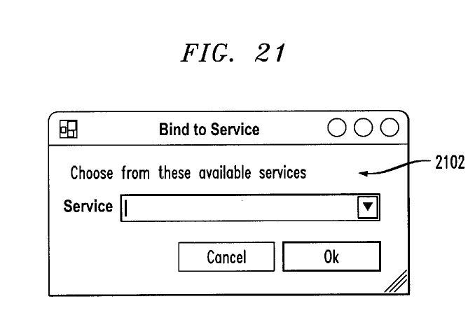

FIG. 20 is a diagram illustrating a screenshot of an exemplary invoking a service option 2002, according to an embodiment of the present invention. By way of example, on the service slide, one can right-click on a task in the service (implementation) plan, and choose “Create/Edit Service Invocation.” One will receive a choice of possible services to select from, as depicted in FIG. 21. FIG. 21 is a diagram illustrating an image of exemplary service invocation choices 2102, according to an embodiment of the present invention.

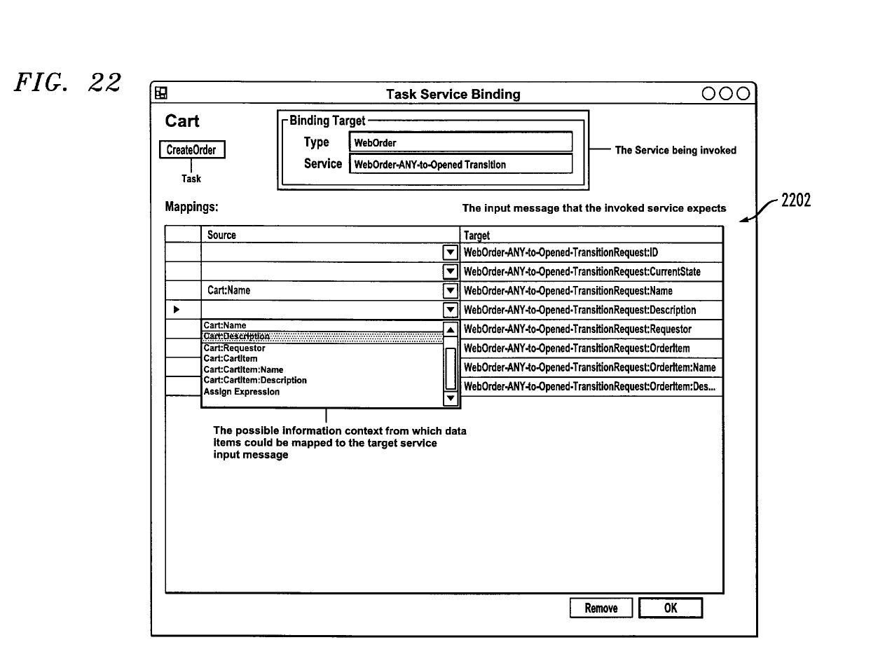

FIG. 22 is a diagram illustrating a screenshot defining invocation mapping 2202, according to an embodiment of the present invention. By way of example, once one has chosen to invoke a service for a task in the service plan, one will see an invocation mapping dialog such as is depicted in FIG. 22. In this dialog, one can map data attributes available in the task's information context to the service input message of the target service that is being invoked. The mapping requirements, for example, can be more complex than just straight mapping an available attribute to a target attribute. Assign Expression, as such, can facilitate complex mapping scenarios.

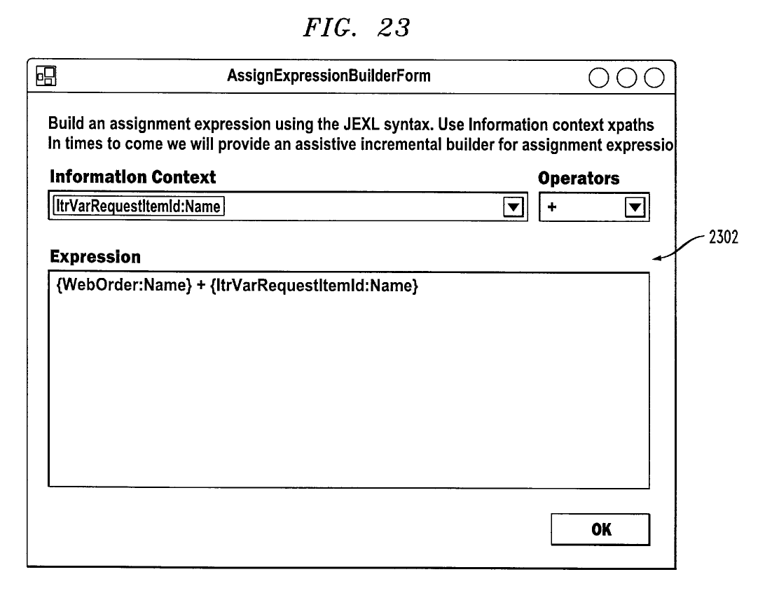

FIG. 23 is a diagram illustrating a screenshot of an exemplary expression builder 2302, according to an embodiment of the present invention. For a task in the service implementation plan, one could leverage and invoke another service. As a part of this invocation, one needs to create and pass the required service (input) message to the target service. Service invocation mappings (as depicted in FIG. 22) are one part of defining such invocations.

While defining service invocation mappings, a straight mapping of what is available in the task's information context to the service-input message may not always be sufficient. One can also apply a processing function on an attribute in the available task information context prior to mapping it to an attribute in the target service (input) message, or one can also pass a literal to the service (input) message. By way of example, an “Assign Expression” option available in the possible information context drop down in the service invocation mapping source column can help model such needs. For example, one can select “Assign Expression” from the drop-down and click anywhere outside that cell to see an Expression Builder.

An information context combo-box can contain the information context items that are available to a user (in the given model context) from which to create an expression. The operators' combo has (for the user) the operators set that one can use in creating an expression. The expression area is where one, by selecting information-context and operators or by direct edit, can formulate the expression. To include literals, for example, one can use double quotes.

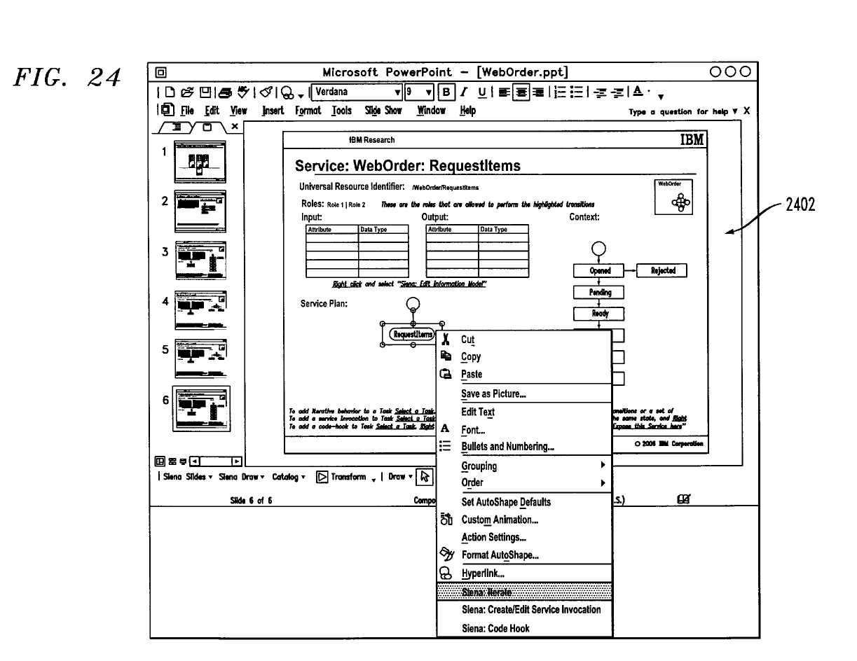

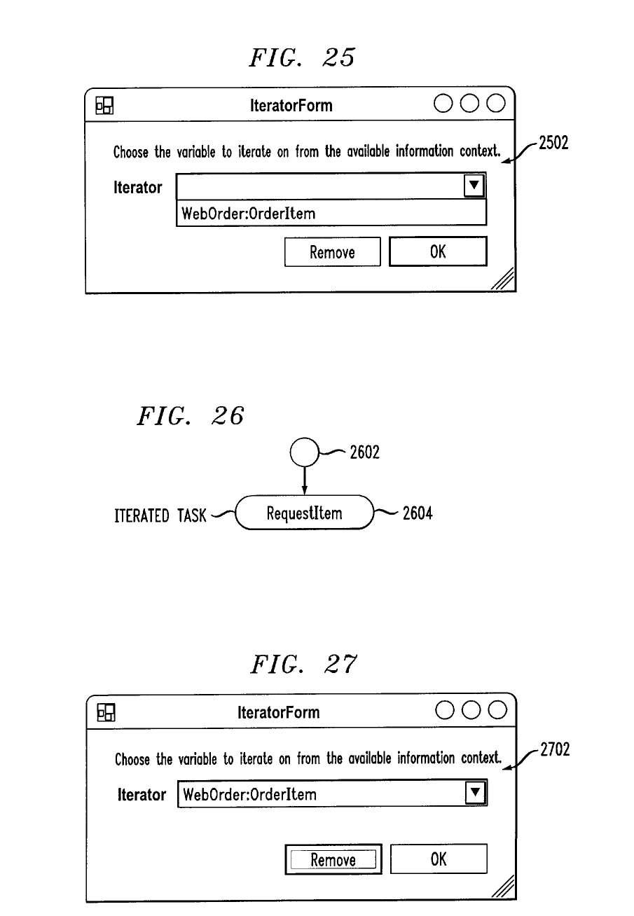

FIG. 24 is a diagram illustrating a screenshot of an exemplary iteration of a task 2402, according to an embodiment of the present invention. By way of example, situations may demand that one performs a particular step (or a set of steps) iteratively based on an enumerated attribute. As such, one can use a task iterator. As depicted in FIG. 24, for example, one can right-click on a task in the service (implementation) plan and choose “Iterate.” This will provide a choice of possible enumerated attributes in the available information context to choose from, as depicted in FIG. 25. FIG. 25 is a diagram illustrating a screenshot of selecting an enumerator on which to iterate 2502, according to an embodiment of the present invention.

FIG. 26 is a diagram illustrating an exemplary iterated task, according to an embodiment of the present invention. By way of illustration, FIG. 26 depicts the start-node 2602 for the flow and a request item 2604. Once an iterator has been defined, the task may begin to appear a little different. In one or more embodiments of the invention, one can define the task-iteration prior to defining the service invocation (for example, to make the iterator variable available in the service invocation and information context).

FIG. 27 is a diagram illustrating a screenshot of removing a task iterator 2702, according to an embodiment of the present invention. By way of example, on a task (in the service plan) already defined as iterative, one can right-click and choose “Iterate.” Additionally, one can click the “Remove” option on the resulting dialog.

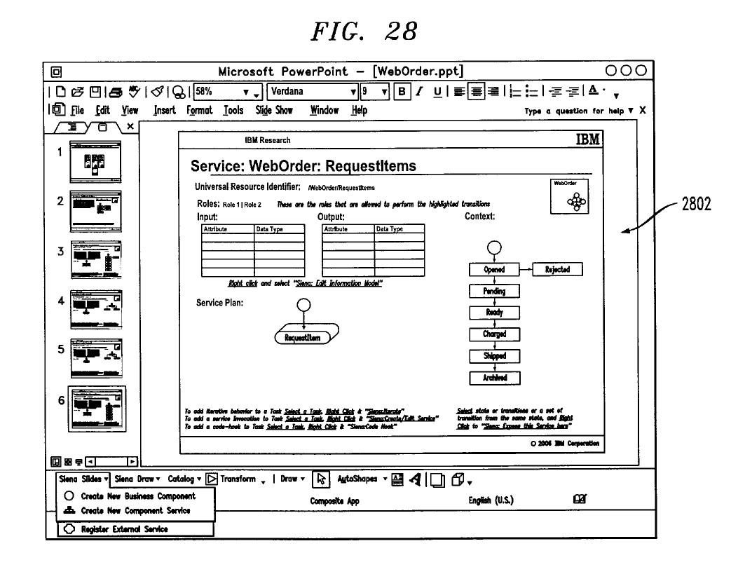

FIG. 28 is a diagram illustrating a screenshot of registering an external service 2802, according to an embodiment of the present invention. To register an external service as a part of the Siena composite application, one can, for example, choose the “Register External Service” option from the Siena slides.

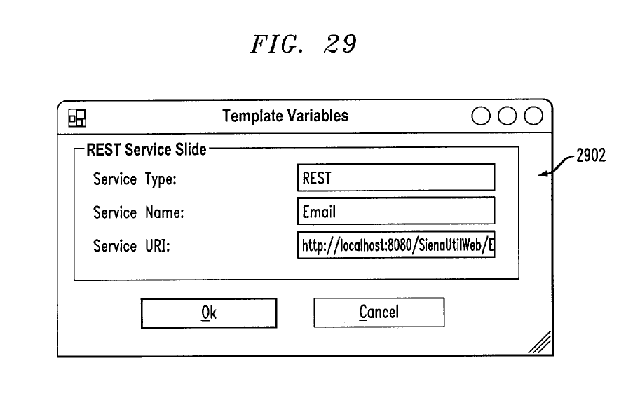

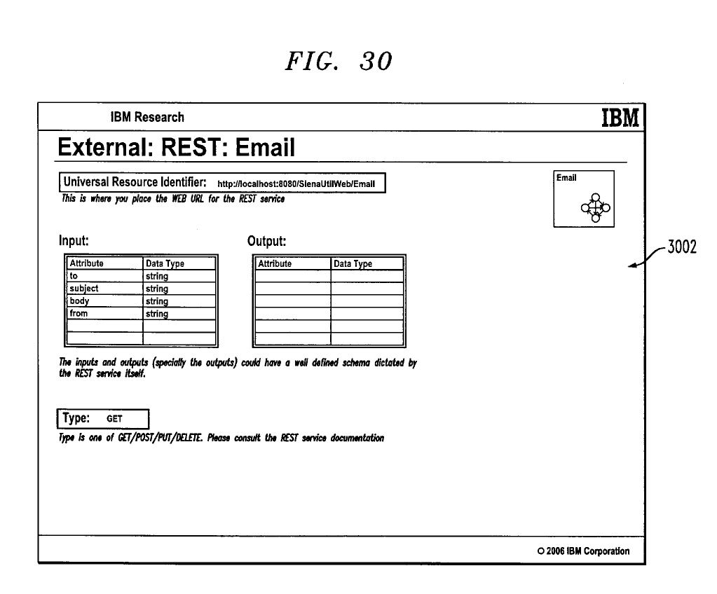

FIG. 29 is a diagram illustrating a screenshot of an exemplary external service wizard dialog 2902, according to an embodiment of the present invention. By way of example, on the resulting Wizard dialog, one can populate the service name and URI. FIG. 30 is a diagram illustrating an exemplary external service slide 3002, according to an embodiment of the present invention. On the resulting slide, one can define the service input and/or output messages, as well as the type.

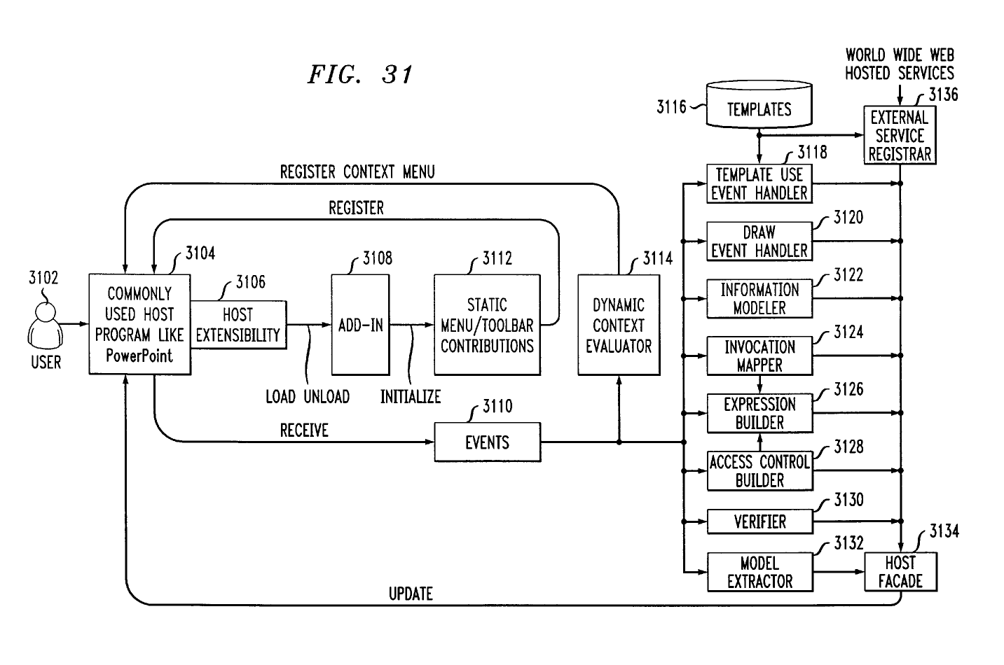

FIG. 31 is a block diagram of a non-limiting exemplary embodiment, according to an aspect of the invention. By way of illustration, FIG. 31 depicts a user 3102 as well as the following components and modules. A host program 3104 includes commonly used software (for example, Microsoft PowerPoint) to which one or more embodiments of the invention can be tied. A host extensibility module 3106 includes the extension API exposed by the host program, such that an apparatus of one or more embodiments of the invention can be loaded and unloaded along with the host program.

An add-in module 3108 implements the host extensibility API, and static menu and/or toolbar contributions 3112 that are the static adds by an apparatus of one or more embodiments of the invention to the static menu and/or toolbar set of the host. An events module 3110 include the general and disclosed-apparatus specified events fired by the host that are of interest to an apparatus of one or more embodiments of the invention. A dynamic context evaluator module 3114 handles general host events of interest such as, for example, drawing/page/slide switch, object selection change, right clicks, etc. This module registers dynamic context menu contributions of an apparatus of one or more embodiments of the invention wherever so intended by the disclosed apparatus.

A template events handler component 3118 includes a logical set of handlers bound to the corresponding set of static or dynamic contributions made by an apparatus of one or more embodiments of the invention towards the use of the offered templates. Templates 3116 include pre-created exemplars associated to the notions of component, service, external-service, organization-roles, security-policy, etc. offered by an apparatus of one or more embodiments of the invention. Also, these can be modified by the user to model his/her specific needs (see, for example, FIG. 4). An external service registrar module 3136 handles fetching, interpretation, and registration of an external service purely based on the uniform resource locator (URL) provided by the user, in context of the external service registration template (see, for example, FIG. 29 and FIG. 30).

A draw event handler component 3120 includes a logical set of handlers bound to the corresponding set of static drawing primitives offered by an apparatus of one or more embodiments of the invention towards simplifying the modeling palette. An information modeler module 3122 allows a visual modeling of the information structure of a component (see, for example, FIG. 14). An invocation mapper module 3124 allows a visual mapping of the information structure that a component has to the information structure that a service to be invoked requires (service input), and vice-versa (also, see, for example, FIG. 22).

An expression builder module 3126 allows a visual expression building by providing the information structure available and the operators and functions available to weave the two into an expression (also, see, for example, FIG. 23). An access control builder module 3128 allows visual expression of an access control policy by combining the roles, privileges (read, modify, and execute), resources (components' information structures, and services in the context of its lifecycles) and rules (see, for example, FIG. 8). A verifier module 3130 verifies the model created by the user (to that point) and reports errors that are detected, if any.

Additionally, a model extractor component 3132 is the handler bound to the extraction event statically registered by an apparatus of one or more embodiments of the invention as a menu and/or toolbar option. It is implicitly invoked in the context of relevant general host events such as, for example, a drawing/page/slide switch to incrementally compile the model, both for performance as well as for making the modeled components available for use in other components. A host facade module 3134 can be implemented in a host-specific manner to allow things such as, for example, persisting of the necessary meta-data in a host specific manner, and/or firing view-update events specific to the host.

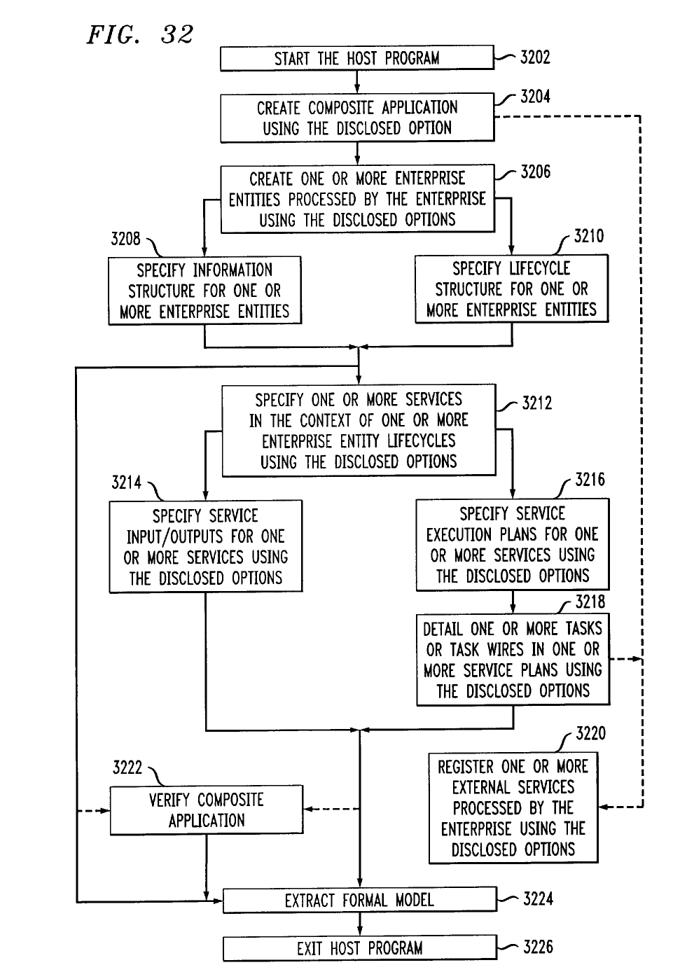

FIG. 32 is a flow diagram illustrating techniques for modeling a composite application (for example, using composite-application templates), according to an embodiment of the present invention. Step 3202 includes starting the host program (such as, for example, PowerPoint). This step also serves to loads the Add-in module (such as, for example, module 3108 in FIG. 31) of an apparatus of one or more embodiments of the invention. The add-in module implements the host's extensibility interface, initializes the static menu/toolbar contributions to the host, and the attaches corresponding handlers to those options.

Step 3204 includes injecting static toolbar/menu options to allow a composite application to be created. A template for a composite application compliant with the host program can be part of the apparatus' templates repository. Also, a mapped template use event handler can create a new host program document when the option is chosen. Step 3206 includes using an apparatus of one or more embodiments of the invention contributed menu/toolbar option towards enterprise entity creation, wherein one or more enterprise entities may be created. A mapped template-use handler selects the enterprise entity component template, merges the entity input supplied by the user into it, and creates a new part (such as, for example, a slide, drawing and/or diagram) compliant with the host document. An apparatus of one or more embodiments of the invention can also fire a host-specific event to update the user's view.

Step 3208 includes using the dynamic context menu contributions on the enterprise entity template to specify information structure for one or more enterprise entities. A mapped event handler of one or more embodiments of the invention uses the information modeler component to model information attributes of enterprise entity. Also, step 3210 includes using the host program cut-copy-paste-rename to add, modify and/or delete states from the lifecycle (that is, specify lifecycle structure) associated to the processing of the enterprise entity. The states may be connected using the host program's notion of connector (also available handily using the draw options statically injected by an apparatus of one or more embodiments of the invention). Further, injected context menu options are available on the state-connectors (transitions) that allow defining guard rules for the transitions. A mapped event handler can use the expression builders to allow defining guard-rules for the transition based on the information structure associated to the enterprise entity.

Step 3212 includes defining enterprise entities (for example, specifying services in the context of one or more enterprise entity lifecycles) using the static menu/toolbar options and/or the dynamic context menu options injected by an apparatus of one or more embodiments of the invention. Mapped handlers recognize the context of the service specification and can automatically associate it to the enterprise entity. Step 3214 includes using the dynamic context menu contributions on the service template to specify input/output information structures for one or more services. Also, a mapped event handler can use the information modeler component of an apparatus of one or more embodiments of the invention to model the input and/or output of the service.

Step 3216 includes using the host program to cut, copy, paste, rename, add, modify and/or delete tasks from the service plan (that is, specify service execution plans) associated to the execution of the service. The tasks may be connected using the host program's notion of connector (also available handily using the draw options statically injected by one or more embodiments of the invention). Additionally, step 3218 includes detailing one or more tasks (or task wires) in one or more service plans using the disclosed options. Injected context menu options are available on the tasks and task-wires (control-flow) and allow simple provision of detailing the tasks. Supported by an apparatus of one or more embodiments of the invention, handler and component tasks can be specified to be iterative (see, for example, FIG. 25 and FIG. 26) or invoked to other available services in the composite application (see, for example, FIG. 20, FIG. 21 and FIG. 22) that allow defining guard rules for the transitions or code-snippets. Also, the context menu options injected on the task-wires can use the expression builder to allow defining conditional-rules for the control-flow.

Step 3220 includes injecting static toolbar/menu options that allow external services to be registered in the context of a composite application. One or more embodiments of the invention includes taking the URL of the external service as an input, and using the external service registrar component in the disclosed status fetches to discover the service specification and register the interface for use in task invocations. Step 3222 includes verifying the composite application (for example, on demand) using the static menu/toolbar options. The errors of verification can be pointed out in the composite application, and in one or more embodiments of the invention, suggestions are offered for possible corrections.

Step 3224 includes injecting static menu/toolbar options to allow extraction of a formal model (for example, extensible markup language (XML) specification of the composite application from the host program document). Also, step 3226 includes exiting the host program. This unloads the apparatus add-in component, and one or more embodiments of the invention can de-register all of the contributions and listeners associated to the host-program.

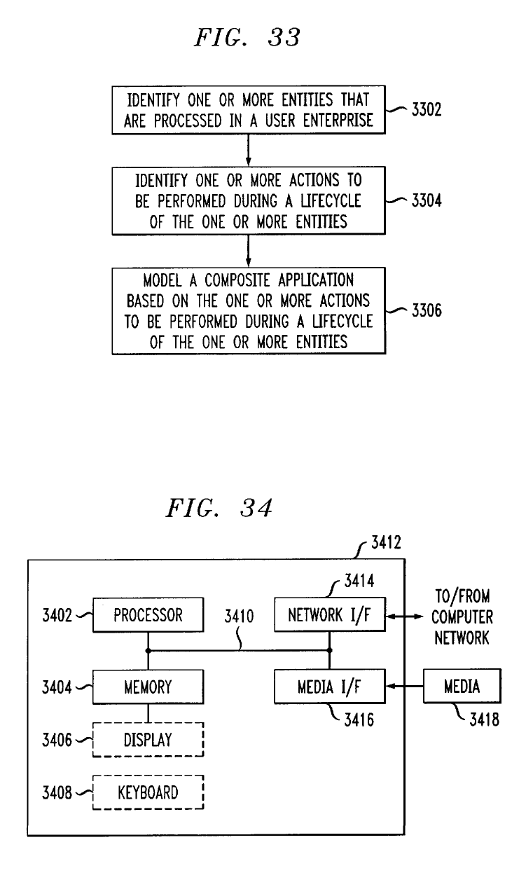

FIG. 33 is a flow diagram illustrating techniques for modeling a composite application (for example, using composite-application templates), according to an embodiment of the present invention. Step 3302 includes identifying one or more entities (for example, enterprise-entities) that are processed in a user enterprise. This step can be carried out, for example, using one or more templates that guide modeling of the entities. Identifying entities that are processed in a user enterprise can include using an enterprise-entity template to specify a lifecycle model of the entities.

Step 3304 includes identifying one or more actions to be performed during a lifecycle of the one or more entities. This step can be carried out, for example, by deciding which of the one or more actions is to be performed during the lifecycle of the entities. Identifying actions to be performed during a lifecycle of the entities can include using a service template to model the actions. The actions can include, for example, communication between entities, a (complex) task-plan with one or more tasks, iterative tasks and computation tasks.

Step 3306 includes modeling a composite application based on the one or more actions to be performed during a lifecycle of the one or more entities. This step can be carried out, for example, using one or more distinct software modules described herein (for example, the components and modules detailed in FIG. 31).

The techniques depicted in FIG. 33 can also include registering one or more external services (for example, REST/WSDL-based external services) in a composite-application. This step can be carried out, for example, using an external service registrar module. Registering external services can also include using an external services template. Additionally, one or more embodiments of the invention include identifying access control needs, as well as using an access control template (for example, along with a simplified access control policy editor) to model the access control needs. This step can be carried out, for example, using an access control builder module.

Further, the techniques depicted in FIG. 33 can include verifying and/or transforming the modeled composite application (for example, using one or more verification options) to a standard software modeling specification. This step can be carried out, for example, using a verifier module and/or a model extractor module. A modeled composite application can be transformed to standard software modeling specifications such as, for example, UML, or enterprise process modeling specifications, etc. Also, because the modeled composite application is exported as an XML, any standard code generation techniques taking that as the input model are also applicable.

The techniques depicted in FIG. 33 can also include, as described herein, providing a system, wherein the system includes distinct software modules, each of the distinct software modules being embodied on a tangible computer-readable recordable storage medium.

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 34, such an implementation might employ, for example, a processor 3402, a memory 3404, and an input/output interface formed, for example, by a display 3406 and a keyboard 3408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 3402, memory 3404, and input/output interface such as display 3406 and keyboard 3408 can be interconnected, for example, via bus 3410 as part of a data processing unit 3412. Suitable interconnections, for example via bus 3410, can also be provided to a network interface 3414, such as a network card, which can be provided to interface with a computer network, and to a media interface 3416, such as a diskette or CD-ROM drive, which can be provided to interface with media 3418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 3418) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a tangible computer-readable storage medium include a semiconductor or solid-state memory (for example memory 3404), magnetic tape, a removable computer diskette (for example media 3418), a random access memory (RAM), a read-only memory (ROM), a rigid magnetic disk and an optical disk (but exclude a propagation medium). Current examples of optical disks include compact disk-read only memory (CD-ROM), compact disk-read/write (CD-R/W) and DVD.

A data processing system suitable for storing and/or executing program code will include at least one processor 3402 coupled directly or indirectly to memory elements 3404 through a system bus 3410. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 3408, displays 3406, pointing devices, and the like) can be coupled to the system either directly (such as via bus 3410) or through intervening I/O controllers (omitted for clarity).

Network adapters such as network interface 3414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 3412 as shown in FIG. 34) running a server program. It will be understood that such a physical server may or may not include a display and keyboard.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a tangible computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, it should be noted that any of the methods described herein can include an additional step of providing a system comprising distinct software modules embodied on a tangible computer readable storage medium; the modules can include any or all of the components shown in FIG. 31. The method steps can then be carried out using the distinct software modules and/or sub-modules of the system, as described above, executing on a hardware processor. Further, a computer program product can include a tangible computer-readable storage medium with code adapted to be executed to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, direct modeling of enterprise-entities as a combination of an information structure, a lifecycle that an information structure gets processed through, and services exposed and consumed in the context of that lifecycle.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for modeling a composite application, comprising the steps of:
identifying one or more entities that are processed in a user enterprise;
identifying one or more actions to be performed during a lifecycle of the one or more entities; and
modeling a composite application based on the one or more actions to be performed during a lifecycle of the one or more entities.

2. The method of claim 1, wherein the one or more actions comprise at least one of communication between one or more entities, a task-plan with one or more tasks, one or more iterative tasks and one or more computation tasks.

3. The method of claim 1, further comprising:
providing a system, wherein the system comprises distinct software modules, each of the distinct software modules being embodied on a tangible computer-readable recordable storage medium;
wherein:
the step of identifying one or more entities that are processed in a user enterprise is carried out using one or more templates that guide modeling of the one or more entities;
the step of identifying one or more actions to be performed during a lifecycle of the one or more entities is carried out by deciding which of the one or more actions is to be performed during the lifecycle of the one or more entities; and
the step of modeling a composite application based on the one or more actions to be performed during a lifecycle of the one or more entities is carried out by the distinct software modules executing on the hardware processor.

4. The method of claim 3, wherein:
the step of identifying one or more entities that are processed in a user enterprise comprises using an enterprise-entity template to specify a lifecycle model of the one or more entities.

5. The method of claim 3, wherein:
the step of identifying one or more actions to be performed during a lifecycle of the one or more entities comprises using a service template to model the one or more actions.

6. The method of claim 3, wherein:
the distinct software modules comprise an external service registrar module, and wherein:
registering one or more external services in a composite-application is carried out by the external service registrar module executing on a hardware processor.

7. The method of claim 6, wherein:
the step of registering one or more external services comprises the external service registrar module, executing on the hardware processor, using an external services template.

8. The method of claim 3, wherein:
the distinct software modules comprise an access control builder module, and wherein:
identifying one or more access control needs is carried out by the access control builder module executing on a hardware processor.

9. The method of claim 3, wherein:
the distinct software modules comprise an access control builder module, and wherein:
using an access control template to model the one or more access control needs is carried out by the access control builder module executing on a hardware processor.

10. The method of claim 3, wherein:
the distinct software modules comprise a verifier module, and wherein:
verifying the composite application is carried out by the verifier module executing on a hardware processor.

11. The method of claim 3, wherein:
the distinct software modules comprise a model extractor module, and wherein:
transforming the composite application to a standard software modeling specification is carried out by the model extractor module executing on a hardware processor.

12. A computer program product comprising a tangible computer readable recordable storage medium including computer useable program code for modeling a composite application, the computer program product including:
computer useable program code for identifying one or more entities that are processed in a user enterprise;
computer useable program code for identifying one or more actions to be performed during a lifecycle of the one or more entities; and
computer useable program code for modeling a composite application based on the one or more actions to be performed during a lifecycle of the one or more entities.

13. The computer program product of claim 12, wherein the one or more actions comprise at least one of communication between one or more entities, a task-plan with one or more tasks, one or more iterative tasks and one or more computation tasks.

14. The computer program product of claim 12, wherein the computer usable program code for modeling a composite application comprises distinct software modules;
wherein:
the step of identifying one or more entities that are processed in a user enterprise is carried out using one or more templates that guide modeling of the one or more entities;
the step of identifying one or more actions to be performed during a lifecycle of the one or more entities is carried out by deciding which of the one or more actions is to be performed during the lifecycle of the one or more entities; and
the distinct software modules comprise the computer usable program code for modeling a composite application based on the one or more actions to be performed during a lifecycle of the one or more entities.

15. The computer program product of claim 14, wherein the computer usable program code for modeling a composite application comprises distinct software modules, the distinct software modules comprising an external service registrar module;
wherein:
the external service registrar module comprises the computer usable program code for registering one or more external services in a composite-application.

16. A system for modeling a composite application, comprising:
a memory; and
at least one processor coupled to the memory and operative to:
identify one or more entities that are processed in a user enterprise;
identify one or more actions to be performed during a lifecycle of the one or more entities; and
model a composite application based on the one or more actions to be performed during a lifecycle of the one or more entities.

17. The system of claim 16, wherein the one or more actions comprise at least one of communication between one or more entities, a task-plan with one or more tasks, one or more iterative tasks and one or more computation tasks.

18. The system of claim 16, further comprising a tangible computer-readable recordable storage medium having distinct software modules embodied thereon;
wherein:
the step of identifying one or more entities that are processed in a user enterprise is carried out using one or more templates that guide modeling of the one or more entities;
the step of identifying one or more actions to be performed during a lifecycle of the one or more entities is carried out by deciding which of the one or more actions is to be performed during the lifecycle of the one or more entities; and
the step of modeling a composite application based on the one or more actions to be performed during a lifecycle of the one or more entities is carried out by the distinct software modules executing on the hardware processor.

19. The system of claim 18, further comprising a tangible computer-readable recordable storage medium having distinct software modules embodied thereon, the distinct software modules comprising an external service registrar module;
wherein:
registering one or more external services in a composite-application is carried out by the external service registrar module executing on a hardware processor.

20. The system of claim 18, further comprising a tangible computer-readable recordable storage medium having distinct software modules embodied thereon, the distinct software modules comprising an access control builder module;
wherein:
using an access control template to model the one or more access control needs is carried out by the access control builder module executing on a hardware processor.
